(19) United States
(12) Patent Application Publication
(10) Pub. No.: US 2008/0124087 A1
(43) Pub. Date: May 29, 2008

(54) Multimode Fibre Optical Communication System

(76) Inventors: Peter Hartmann, Cambridge (GB); Richard Vincent Penty, Hertfordshire (GB); Ian Hugh White, Cambridgeshire (GB); Alwyn John Seeds, London (GB)

Correspondence Address: GOODWIN PROCTER LLP;PATENT ADMINISTRATOR, EXCHANGE PLACE, BOSTON, MA, 02109-2881, US

(21) Appl. No.: 11/660,625

(22) PCT Filed: Aug. 20, 2004
(86) PCT No.: PCT/GB04/03593

§ 371 Date: Feb. 20, 2007

(51) Int. Cl. H04B 10/12; H04B 10/13

(52) U.S. Cl. 398/115; 398/200

(57) ABSTRACT

A method of transmission of radio signals over all types of graded-index multimode fibre is provided. The method comprises launching optical radiation into the core of the multimode fibre with a specified restricted launch to allow multiple trans-verse mode lasers transmitters to be used in low cost radio over fibre links. The launch technique allows a reduction in modal dispersion and modal interference, thus greatly improving the transmission performance of radio over fibre signals over multimode fibre as well as reducing system impairments such as outages and link failures.

### FIELD OF THE INVENTION

This invention relates to an optical communication system which transmits optical signals over multimode fibre. In particular it relates to the transmission of radio frequency signals over multimode fibre using a multimoded optical launch into the fibre.

### PRIOR ART KNOWN TO THE APPLICANT

Network operators who wish to deploy cellular radio or wireless LAN systems within buildings are interested in high quality ways of providing in-building coverage. One of the most effective and efficient ways of providing this coverage is to place the base station either inside the building or remotely, and to use a distributed antenna system (DAS) to provide a relatively uniform signal strength to the mobile user. DASs are currently usually constructed using coaxial cable. However for longer spans it is likely that optical fibre will become the preferred solution because its insertion loss is virtually independent of link length (at least in comparison with coaxial cable), simplifying the system design and future extensions to the distribution system.

Today analogue radio over fibre optical links are in use in many commercial DAS installations. However, these installations transmit the radio over fibre signal within the low pass bandwidth of the fibre used. Thus such systems use either single mode fibre (SMF) to provide the necessary transmission bandwidth or use multimode fibre (MMF) at an intermediate frequency that is within the low pass bandwidth of the multimode fibre. The first approach has the disadvantage that it requires specially installed fibre since the installed fibre base within buildings is predominantly multimode. The second approach requires the simultaneous transmission of a low frequency reference tone for phase locking the remote local oscillators required for signal conversion between the intermediate frequency and the required radio frequency. Consequently each approach results in a high installation cost as well as greater cost of ownership as a consequence of the high complexity of such systems. This has lead to a low take up of radio over fibre technology for distributing radio signals such as cellular radio or wireless LAN.

Installed base multimode fibre typically has a specified bandwidth-length product of 160 MHz.km at 850 nm and 500 MHz.km at 1300 nm wavelength. This bandwidth is specified for over-filled launch, where all the modes supported in the fibre are excited equally. Consequently a radio over multimode fibre system operating at 850 nm and transmitting at a carrier frequency of 2 GHz would be limited to a transmission distance of 80 m to ensure that the signal was within the low pass bandwidth of the fibre. This severely limits the application of such systems to very small installations and hence they are currently not preferred to those described above.

It is known that multimode fibres possess a significant passband response beyond the 3 dB bandwidth. This can allow the successful transmission of digital signals when these are upconverted onto a radio frequency subcarrier. This was first described in Raddatz et al., “High Bandwidth Multimode Fibre Links using Subcarrier Multiplexing in Vertical Cavity Surface Emitting Lasers”, in Optical Fibre Communication Conference, OSA Technical Digest (Optical Society of America, Washington D.C., 1998), 358-359.

Furthermore, Wake et al. showed (Electronics Letters, vol. 37, pp. 1087-1089, 2001) that it was possible to transmit radio frequency signals over multimode fibre by operating at frequencies in this flat-band region beyond the 3 dB bandwidth of the fibre. Whilst this work demonstrated the feasibility of transmitting such signals over longer lengths of multimode fibre than previously thought possible, it only demonstrated this for high quality fibres. Subsequently it was shown in the UK patent application no. 0229238.1 “AN OPTICAL COMMUNICATION SYSTEM” that it was possible to ensure that signal transmission over the fibre occurs in a stable operating regime for all guarantee high quality transmission of a radio signal.

It is well known that the bandwidth of multimode fibre is limited by dispersion. The two main types of dispersion observed in multimode fibre are chromatic dispersion, where the refractive index of the fibre varies with the wavelength of the light, and modal dispersion, where the different modes of the multimode optical fibre travel at different group velocities. Whilst the relative contributions of the two types of dispersion vary with fibre type, typically the bandwidth of multimode fibre is limited by modal dispersion.

The modal bandwidth depends strongly on the specific modes excited in the multimode fibre and so the optical launch conditions can have a great effect on the achievable transmission distance for signals within the low pass bandwidth of the fibre. Consequently restricted launch schemes have been developed to maximise this distance. Two such schemes are centre launch and offset launch.

In the centre launch scheme, the optical power from a single mode optical transmitter is coupled into the centre of a multimode optical fibre. This predominantly excites the fundamental mode of the fibre and consequently greatly increases its bandwidth. For many fibres this works very well. However a significant number of fibres contain defects in their refractive index profile which results in very poor bandwidth performance using this centre launch scheme.

In the offset launch scheme a single mode transmitter launches light into a region offset from the centre of the fibre. Here the optical power is coupled into the higher order modes which tend to have reasonably low relative modal dispersion and can, in contrast to centre launch, guarantee the low pass bandwidth performance of multimode fibres. This technique is described in L Raddatz et al., “Influence of Restricted Mode Excitation on Bandwidth of Multimode Fibre Links”, Photonics Technology Letters, vol. 10, pp. 534-536, 1998 and the PCT patent specification no. WO97/3330 “MULTIMODE COMMUNICATIONS SYSTEMS”. Offset launch was the basis of the UK patent application no. 0229238.1 “AN OPTICAL COMMUNICATION SYSTEM”. It allows a reduction in modal dispersion and modal interference and smoothing of the frequency response passband region beyond the fibres specified 3 dB base band bandwidth assisting RF transmission and recovery within this region.

The present invention goes beyond these examples of prior art. Many low cost optical transmitters used in multimode fibre systems have multiple transverse modes. The prior art described above relies on single mode optical launches into the multimode fibre whereas this invention relates to the use of multiple transverse mode launches.

The essence of the present invention is that the use of defined restricted mode launch schemes from the multiple transverse mode optical transmitter can result in stable and robust radio frequency signal transmission for all types of multimode fibre. This would enable the use of low cost multiple transverse mode transmitters along with the pre-installed multimode fibre base for DAS applications such as cellular radio and wireless LAN systems. One benefit would be that it would not be necessary to measure fibre performance in situ or to install fibre specifically for this application.

This approach is a fundamental distinction over known existing digital communications systems using restricted launch and multiple transverse mode optical transmitters. These are currently limited to operating within the baseband bandwidth specification of the fibre. They cannot provide the required performance for radio frequency signals over multimode fibre that this invention achieves.

It should be stressed that the advance should apply to all signal distribution schemes whose bandwidths are greater than the 3 dB transmission bandwidth of the optical fibre, and which rely on advanced or multi-state coding, decoding or equalisation to achieve low error rate. Here the technique ensures that frequencies do not fade or drop-out so that the coded spectra do not suffer high localised energy loss that reduce the benefits of the advanced or multi-state coding or the potential for signal enhancement by decoding or equalisation, for example.

The invention therefore represents an advance over existing techniques in the field; with advantageous results flowing from its application.

### SUMMARY OF THE INVENTION

An optical communication system comprising:
one or more optical radiation transmitters;
a means of coupling optical radiation from the, or each, optical radiation transmitter into a multimode fibre using a launch which restricts the number of modes excited in the fibre and
a photodetector;
   characterised by the feature that the, or each, optical radiation transmitter is a multiple transverse mode laser transmitter and that the transmission signals used are radio frequency signals.

The preferred method of ensuring that the correct restricted set of modes is excited in the fibre to enable high quality radio over fibre transmission is to limit the proportion of encircled flux launched into the fibre within a certain radius from the centre and to limit the radius within which a higher proportion of encircled flux is launched.

In such an optical communication system, where the fibre has a core diameter of 62.5 μm, where the operating wavelength is 850 nm and where the laser transmitter is a multiple transverse mode Vertical Cavity Surface Emitting Laser (VCSEL), the preferable encircled flux launch condition is:
greater than 75% of the encircled flux within a circle of radius 25 μm with a centre at the centre of the multimode fibre core.

Other features of the invention will become apparent from the description which follows.

### BRIEF DESCRIPTION OF THE DRAWINGS

The present invention will now be described more particularly with reference to the accompanying drawings which show, by way of example only, a preferred embodiment of the optical communication system according to the invention.

In the drawings:

FIG. 1 presents experimental results achieved using an infrared (IR) camera showing the nearfield of the lasing device for a typical operating-condition.

FIG. 2 presents experimental results achieved using an optical spectrum analyzer (OSA) showing the emitting spectrum of the lasing device for a variety of bias currents.

FIG. 3 presents an experimental configuration for demonstrating the preferred embodiment according to the invention.

FIG. 4 presents experimental results achieved with the experimental configuration of FIG. 3 comparing Error Vector Magnitude (EVM) and offset position over a short length of low performance fibre.

FIG. 5 presents experimental results achieved with the experimental configuration of FIG. 3 performing the experiment as in FIG. 4 but with a different fibre of the same length.

### DETAILED DESCRIPTION OF THE DRAWINGS

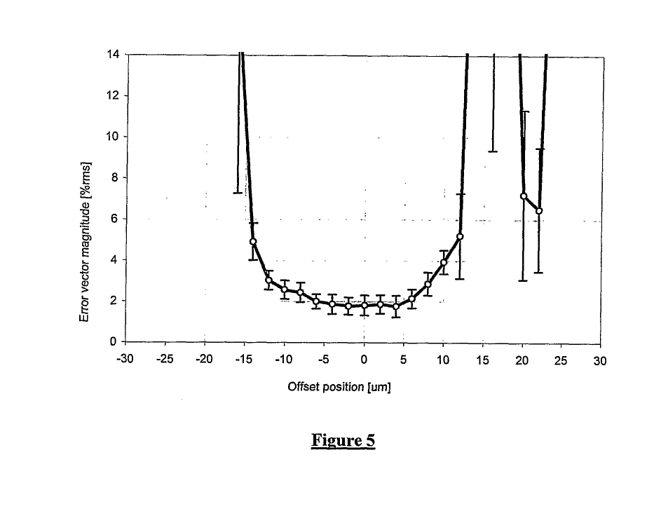

The multiple transverse mode lasing device used in this work was a proton implanted VCSEL with an aperture diameter of 15 μm. The VCSEL had a threshold current of 3.5 mA. FIG. 1 shows the measured near field of the lasing device used in the experiments for the results depicted in FIGS. 4-5. To obtain this measurement the light emitting from the laser diode was focussed onto an IR-camera using bulk optics. The lasing device was biased at a current of 10 mA, which is well above threshold. The drawing shows six bright spots arranged in a starshaped pattern. These spots correspond to power-peaks in the nearfield of the device, proving it to be multimode in the transverse (lateral) direction.

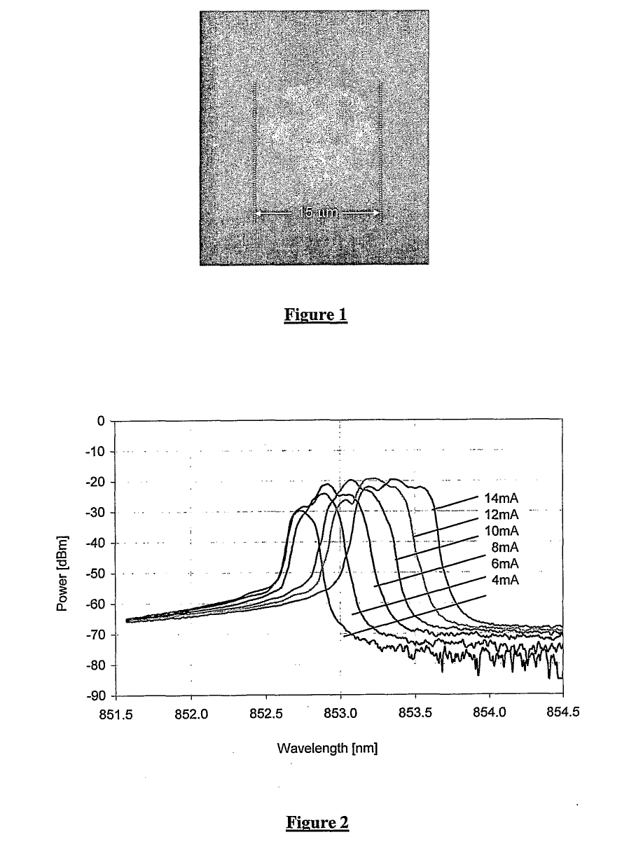

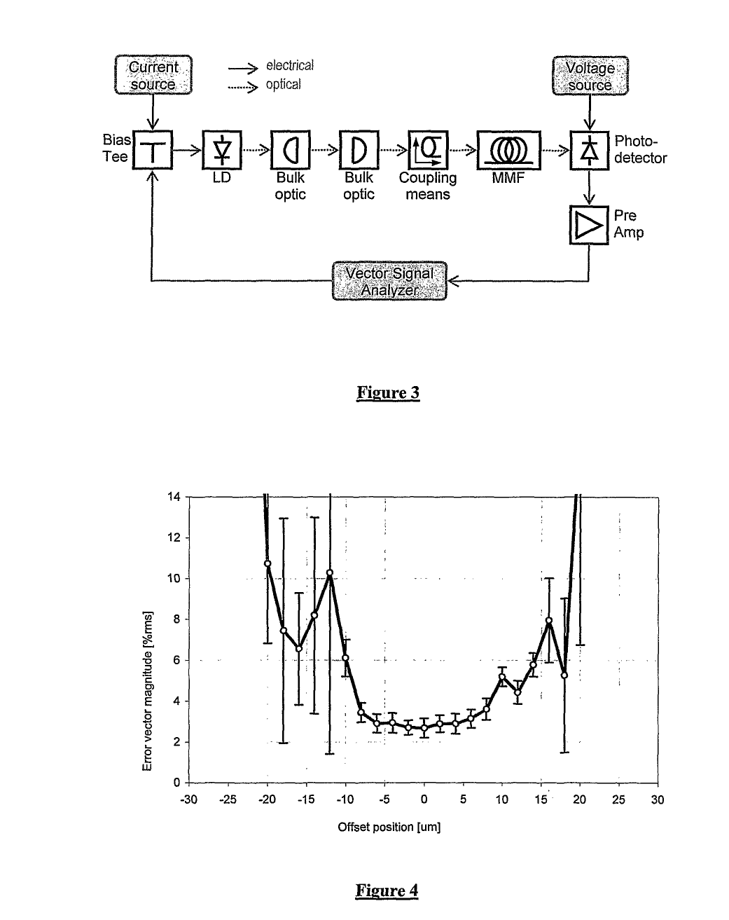

FIG. 2 depicts the measured optical spectrum of the lasing device. The resolution of the instrument is 0.08 nm though the modes of the lasing action are too close to be observed. The set-up to for this experiment was very similar to the one presented in FIG. 3, except that no RF signal was applied to the lasing device and the output of the multimode fibre was directly connected to the input of a multimode optical spectrum analyzer (OSA). The drawing shows the measured spectrum for several bias currents ranging from 4 mA to 14 mA. It can be seen that the shift in wavelength is approximately 0.09 nm/mA increase in bias current with the peak's full width at half maximum (FWHM) spectral width increasing from 0.24 nm at 4 mA to 0.59 nm at 14 mA. The observed spectrum is very typical for a laterally multimoded VCSEL.

Referring to FIG. 3, the preferred embodiment of the Optical Communications System 11 according to the invention comprises a signal input means 12 (in this case a bias T), an optical radiation source 13, collimating bulk optics 14, focussing bulk optics 15, launching means 16, a multimode fibre 17, a photodetector 18, signal amplification means 19, signal analysing means 20, a current source 21 and a voltage source 22 when configured for testing and evaluation of a plurality of launch conditions and fibre responses.

The effect of restricted launch on the transmission of high frequency radio signals over ‘worst-case’ multimode fibre using a complex digital modulation format (16-QAM) was measured in a series of experiments in order to determine the best strategy for ensuring good quality radio over fibre transmission over multimode fibre. 16-QAM (16 state quadrature amplitude modulation) encodes 4 bits into one symbol by varying the amplitude and phase of the carrier signal. Error vector magnitude (EVM) was used as the link performance metric in this series of measurements.

The optical radiation source 13 is a multi transverse mode laser. The laser 13 is an uncooled 850 nm vertical cavity surface emitting laser (VCSEL) device.

The light beam from the laser 13 was collimated and focussed onto the multimode fibre facet 17 using a collimating lens 14, a focussing lens 15. Both lenses have a magnification of 20.

A precision xyz-stage 16 was used to control the launch conditions into various combinations of reels of ‘worst-case’ multimode fibre 17. In this case, in order to obtain very high precision the stage was electrically controlled with a piezo-electric controller.

Experimental results shown in FIGS. 4 and 5 were achieved using 300 m lengths of multimode fibre having a 62.5 μm core diameter. These fibres were the same as used for the standardisation of the offset launch technique described in the Gigabit Ethernet standard, IEEE 802.3z, 1998. Therefore all fibres had bandwidths near the specified limit of 500 MHz.km at 1300 nm wavelength.

The receiving sub-system converts the low intensity modulated light back into an electrical signal. It consists of a photodetector 18 and an amplification stage 19. The photodetector 18 is a broadband photodiode, with the photodiode having a multimode fibre 17 input. The amplification stage is a high gain electrical preamplifier 19.

The signal generating and analysing means 20 consists of a vector signal generator which has the ability to generate a 16-QAM signal at a centre frequency of 2 GHz with a symbol rate of 2 Ms/s and a vector signal analyzer which has the ability to demodulate a 16-QAM signal at a centre frequency of 2 GHz with a symbol rate of 2 Ms/s. 16-QAM modulation was chosen as it is representative of wireless communication modulation systems. Further it requires very high signal-to-noise-ratio (SNR) and therefore provides a good test of the link performance. It should be noted that the electrical back to back EVM floor of the instrument used was 2%. Therefore any received EVM values close to 2% after transmission over the optical link represent the fact that the optical transmission has added only a very small amount of EVM penalty.

FIG. 4 shows error vector magnitude (EVM) as a function of offset position. The laser 13 was operated at a bias current of 10 mA and at a temperature of 25° C. in an uncooled environment. The solid line in this plot shows the root-mean-square (RMS) value of EVM calculated from repeated measurements over a time period of a few minutes. The error bars associated with each measurement indicate the standard deviation of the measured EVM for the specific offset.

From FIG. 4 it can be seen that the most stable region of operation is at an offset position less than 9 μm. In this region both the EVM and the variability of EVM over time are both very low. There are also regions at higher offsets (approximately 15 μm-18 μm) having EVM nearly as low as in the region mentioned above. However at these offset position the standard deviation and therefore the variation in time is substantially greater and there is a high probability that the EVM at some point of time has an unacceptably high value. In the stable region the EVM is as low as 2.70% rms

With reference to FIG. 5, the previous experiment was repeated using a different fibre but of the same type and length. Again the solid line represents the measured EVM and the error bars depict one standard deviation on either side of the curve. The measured results show a very similar behaviour of the EVM as a function of offset position. Here the most stable region of operation is at an offset position of less than 13 μm. However in this experiment no local dips at higher offset have been observed which could result in acceptable data-transmission. The minimum EVM in the stable region in this experiment was below 2% rms.

When combining the results from these experiments one finds that in order to provide good link performance one has to apply a restricted launch condition. For each of these cases, the restricted launch can be characterised by an 80% encircled flux within a circle radius of 12 μm centred on the core of the multimode fibre. Clearly this relies on the multiple transverse mode launch not being an offset launch scheme similar to that described in PCT patent specification no. WO97/3330 “MULTIMODE COMMUNICATIONS SYSTEMS”.

Minimum EVM degradation correlates to smoothing of the RF transmission region beyond the 3 dB bandwidth specification of the multimode fibre. As a result of this effect susceptibility of signal loss due to transmission nulls is substantially eliminated.

The metrics for quality include, but are not restricted to:
spurious free dynamic range (SFDR);
third order intercept point (IP3);
error vector magnitude (EVM);
and the variability of these parameters over time to ensure that no failures of signal transmission (outages) occur.

Types of graded-index multimode fibre that can be used include, but are not restricted to:
old fibre that has previously been installed within buildings;
new fibre;
silica fibre;
plastic fibre;
fibre with multiples splices and/or connectors;
fibre with low specified bandwidth; and
fibre with high specified bandwidth.

The means of coupling include, but are not restricted to:
a launch from a multiple transverse mode laser with collimating and focussing bulk optics into a graded-index multimode fibre.
a launch from a laser receptacle package into a graded-index multimode fibre where the launch is such that it meets the restricted launch specification for the specific fibre type

The scope of the invention is defined by the claims which now follow.

1. An optical communication system comprising:
one or more optical radiation transmitters;
a means of coupling optical radiation from the, or each, optical radiation transmitter into a multimode fibre using a launch which restricts the number of modes excited in the fibre; and
a photodetector;
characterised by the feature that the, or each, optical radiation transmitter is a multiple transverse mode laser transmitter and that the transmission signals used are radio frequency signals.
An optical communications link according to claim 1 where other optical or optoelectronic components, such as modulators and amplifiers, are included in the link.
An optical communication system according to claims 1 or 2 where the means of coupling light into the fibre produces a launch which is restricted within the fibre such that the relative power in both high and low order modes is limited with respect to intermediate order modes.
An optical communication system according to claim 3 where the fibre has a core diameter of 62.5 μm and where the multiple mode transmitter provides a launch characterised by greater than 75% of the encircled flux being within a circle of radius 25 μm with a centre at the centre of the multimode fibre core.
An optical communication system where the multiple mode output of the source is modified to provide high quality radio over fibre transmission but with relaxed alignment tolerances.
An optical communication system according to claim 3 where the necessary fibre modes are excited using some equivalent launch technique to the above, such as an angled launch.
An optical communication system, according to the above claims whereby high frequencies, beyond the fibre bandwidth, are required for successful information transmission. Such systems include those using advanced multistate coding and decoding, or those involving equalisation.
An optical communication system as substantially described with reference to and as illustrated in any appropriate combination of the accompanying text and drawings.
